(19) United States
(12) Patent Application Publication
(10) Pub. No.: US 2023/0175104 A1
(43) Pub. Date: Jun. 8, 2023

(54) Cold rolled and annealed steel sheet and method of manufacturing the same

(71) Applicant: ArcelorMittal, Luxembourg (LU)

(72) Inventors: Astrid PERLADE, Le Ban-Saint-Martin (FR); Kangying ZHU, Metz (FR); Frédéric KEGEL, Yutz (FR); Blandine REMY, Sanry les Vigy (FR)

(21) Appl. No.: 18/016,396

(22) PCT Filed: Jul. 12, 2021
(86) PCT No.: PCT/IB2021/056233

§ 371 Date: Jan. 16, 2023

(30) Foreign Application Priority Data
Jul. 24, 2020 (IB) PCT/IB2020/056993

(51) Int. Cl. C22C 38/04; C22C 38/14; C22C 38/12; C22C 38/06; C22C 38/02; C22C 38/00; C21D 9/46; C21D 8/02; C21D 6/00

(52) U.S. Cl. CPC C22C 38/04; C22C 38/14; C22C 38/12; C22C 38/06; C22C 38/02; C22C 38/002; C22C 38/001; C21D 9/46; C21D 8/0205; C21D 8/0236; C21D 8/0263; C21D 6/008; C21D 6/005; C21D 2211/001; C21D 2211/005; C21D 2211/008; C21D 8/0226; B23K 11/11

(57) ABSTRACT

A cold rolled and annealed steel sheet, made of a steel having a composition including, by weight percent
C: 0.03-0.18%
Mn: 6.0-11.0%
Al: 0.2-3%
Mo: 0.05-0.5%
B: 0.0005-0.005%
S≤0.010%
P≤0.020%
N≤0.008%
and including optionally one or more of the following elements, in weight percentage:
Si≤1.20%
Ti≤0.050%
Nb≤0.050%
Cr≤0.5%
V≤0.2%
the remainder of the composition being iron and unavoidable impurities resulting from the smelting, the steel sheet having a microstructure including, in surface fraction,
   from 30% to 55% of retained austenite,
   from 45% to 70% of ferrite,
   less than 5% of fresh martensite
   a carbon [C]_{A} and manganese [Mn]_{A} content in austenite, expressed in weight percent, satisfying

[C]_{A}*[Mn]_{A}/((0.1+C %²)*(Mn %+2))≥1.10
and an inhomogeneous repartition of manganese characterized by a manganese distribution with a slope above or equal to −30.

The present invention relates to a high strength steel sheet having good weldability properties and to a method to obtain such steel sheet.

### BACKGROUND

To manufacture various items such as parts of body structural members and body panels for automotive vehicles, it is known to use sheets made of DP (Dual Phase) steels or TRIP (Transformation Induced Plasticity) steels.

One of the major challenges in the automotive industry is to decrease the weight of vehicles in order to improve their fuel efficiency in view of the global environmental conservation, without neglecting the safety requirements. To meet these requirements, new high strength steels are continuously developed by the steelmaking industry, to have sheets with improved yield and tensile strengths, and good ductility and formability.

### SUMMARY OF THE INVENTION

One of the developments made to improve mechanical properties is to increase content of manganese in steels. The presence of manganese helps to increase ductility of steels thanks to the stabilization of austenite. But these steels present weaknesses of brittleness. To overcome this problem, elements as boron are added. These boron-added chemistries are very tough at the hot-rolled stage but the hot band is too hard to be further processed. The most efficient way to soften the hot band is batch annealing, but it leads to a loss of toughness.

In addition to these mechanical requirements, such steel sheets have to show a good resistance to liquid metal embrittlement (LME). Zinc or Zinc-alloy coated steel sheets are very effective for corrosion resistance and are thus widely used in the automotive industry. However, it has been experienced that arc or resistance welding of certain steels can cause the apparition of particular cracks due to a phenomenon called Liquid Metal Embrittlement (“LME”) or Liquid Metal Assisted Cracking (“LMAC”). This phenomenon is characterized by the penetration of liquid Zn along the grain boundaries of underlying steel substrate, under applied stresses or internal stresses resulting from restraint, thermal dilatation or phases transformations. It is known that adding elements like carbon or silicon are detrimental for LME resistance.

The automotive industry usually assesses such resistance by limiting the upper value of a so-called LME index calculated according to the following equation:

LME index=C %+Si %/4,

wherein % C and % Si stands respectively for the weight percentages of carbon and silicon in the steel.

The publication WO2020011638 relates to a method for providing medium to intermediate manganese (Mn between 3.5 to 12%) cold-rolled steels with a reduced carbon content. Two process routes are described. The first one includes a single intercritical annealing of the cold rolled steel sheet. The second one includes a double annealing of the cold rolled steel sheet, the first one being fully austenitic, the second one being intercritical. Thanks to the choice of the annealing temperature, a good compromise of tensile strength and elongation is obtained. But the tensile strength of the steel sheet does not go higher than 980 MPa.

An object of the present invention is to provide a cold rolled and annealed steel sheet having a combination of high mechanical properties with the tensile strength TS above or equal to 1050 MPa, the yield strength YS above or equal to 780 MPa, the uniform elongation UE above or equal to 13%, the total elongation TE above or equal to 15% without deteriorating weldability properties. Preferably, the cold rolled annealed steel sheet according to the invention has a LME index of less than 0.36. Preferably, the cold rolled and annealed steel sheet has a hole expansion ration HE above or equal to 15%.

Preferably, the cold rolled and annealed steel sheet according to the invention has a carbon equivalent Ceq lower than 0.4%, the carbon equivalent being defined as

Ceq=C %+Si %/55+Cr %/20+Mn %/19−Al %/18+2.2P %−3.24B %−0.133*Mn %*Mo %

with elements being expressed by weight percent.

Preferably, the resistance spot weld of two steel parts of the cold rolled and annealed steel sheet according to the invention has an α value of at least 30 daN/mm2.

Preferably, the cold rolled annealed steel sheet according to the invention satisfies [(TS-800)×(YS-300)×UE×TE]/[(0.1+C %)×Mn %]>3.3×10⁷, where TS and YS are expressed in MPa, UE and TE in % and C % and Mn % are the nominal concentrations in wt %.

The present invention provides a cold rolled and annealed steel sheet, made of a steel having a composition comprising, by weight percent:
C: 0.03-0.18%
Mn: 6.0-11.0%
Al: 0.2-3%
Mo: 0.05-0.5%
B: 0.0005-0.005%
S≤0.010%
P≤0.020%
N≤0.008%
and comprising optionally one or more of the following elements, in weight percentage:
Si≤1.20%
Ti≤0.050%
Nb≤0.050%
Cr≤0.5%
V≤0.2%
the remainder of the composition being iron and unavoidable impurities resulting from the smelting, said steel sheet having a microstructure comprising, in surface fraction,
   from 30% to 55% of retained austenite,
   from 45% to 70% of ferrite,
   less than 5% of fresh martensite
   a carbon [C]_{A} and manganese [Mn]_{A} content in austenite, expressed in weight percent, satisfying

[C]_{A}*[Mn]_{A}/((0.1+C %²)*(Mn %+2))≥1.10
C % and Mn % being the nominal values in carbon and manganese in weight percent,
   and an inhomogeneous repartition of manganese characterized by a manganese distribution with a slope above or equal to −30.

### BRIEF DESCRIPTION OF THE DRAWINGS

FIG. 1 represents a section of the hot rolled and heat-treated steel sheet of trial 1 and trial 10.

FIG. 2 shows a plotted curve of accumulated area fraction with respect to Mn content for trial 1 and 10.

### DETAILED DESCRIPTION

The invention will now be described in detail and illustrated by examples without introducing limitations.

According to the invention the carbon content is from 0.03% to 0.18% to ensure a satisfactory strength and good weldability properties. Above 0.18% of carbon, weldability of the steel sheet and the resistance to LME may be reduced. The temperature of the soaking depends in particular on carbon content: the higher the carbon content, the lower the soaking temperature to stabilize austenite. If the carbon content is lower than 0.03%, the austenite fraction is not stabilized enough to obtain, after soaking, the desired tensile strength and elongation. In a preferred embodiment of the invention, the carbon content is from 0.05% to 0.15%. In another preferred embodiment of the invention, the carbon content is from 0.07% to 0.12%.

The manganese content is from 6.0% to 11.0%. Above 11.0% of addition, weldability of the steel sheet may be reduced, and the productivity of parts assembly can be reduced. Moreover, the risk of central segregation increases to the detriment of the mechanical properties. As the temperature of soaking depends on manganese content too, the minimum of manganese is defined to stabilize austenite, to obtain, after soaking, the targeted microstructure and strengths. Preferably, the manganese content is from 6.5% to 9.0%.

According to the invention, aluminium content is from 0.2% to 3% to decrease the manganese segregation during casting. Aluminium is a very effective element for deoxidizing the steel in the liquid phase during elaboration. Above 3% of addition, the weldability of the steel sheet may be reduced, so as cast ability. Moreover, tensile strength above 980 MPa is difficult to achieve. Moreover, the higher the aluminium content, the higher the soaking temperature to stabilize austenite. Aluminium is added at least 0.2% to improve product robustness by enlarging the intercritical range, and to improve weldability. Moreover, aluminium is added to avoid the occurrence of inclusions and oxidation problems. In a preferred embodiment of the invention, the aluminium content is from 0.5% to 1.5%.

Molybdenum content is from 0.05% to 0.5% in order to decrease the manganese segregation during casting. Moreover, an addition of at least 0.05% of molybdenum provides resistance to brittleness. Above 0.5%, the addition of molybdenum is costly and ineffective in view of the properties which are required. In a preferred embodiment of the invention, the molybdenum content is from 0.1% to 0.3%.

According to the invention, the boron content is from 0.0005% to 0.005% in order to improve toughness of the hot rolled steel sheet and the spot weldability of the cold rolled steel sheet. Above 0.005%, the formation of boro-carbides at the prior austenite grain boundaries is promoted, making the steel more brittle. In a preferred embodiment of the invention, the boron content is from 0.001% to 0.003%.

Optionally some elements can be added to the composition of the steel according to the invention.

The maximum addition of silicon content is limited to 1.20% in order to improve LME resistance. In addition, this low silicon content makes it possible to simplify the process by eliminating the step of pickling the hot rolled steel sheet before the hot band annealing. Preferably the maximum silicon content added is 0.5%.

Titanium can be added up to 0.050% to provide precipitation strengthening. Preferably, a minimum of 0.010% of titanium is added in addition of boron to protect boron against the formation of BN.

Niobium can optionally be added up to 0.050% to refine the austenite grains during hot-rolling and to provide precipitation strengthening. Preferably, the minimum amount of niobium added is 0.010%.

Chromium and vanadium can optionally be respectively added up to 0.5% and 0.2% to provide improved strength

The remainder of the composition of the steel is iron and impurities resulting from the smelting. In this respect, P, S and N at least are considered as residual elements which are unavoidable impurities. Their content is less than or equal to 0.010% for S, less than or equal to 0.020% for P and less than or equal to 0.008% for N.

The microstructure of the cold rolled and annealed steel sheet according to the invention will now be described. It contains, in surface fraction:
from 30% to 55% of retained austenite,
from 45% to 70% of ferrite,
less than 5% of fresh martensite
a carbon [C]_{A} and manganese [Mn]_{A} content in austenite, expressed in weight percent, satisfying

[C]_{A}*[Mn]_{A}/((0.1+C %²)*(Mn %+2))≥1.10
C % and Mn % being the nominal values in carbon and manganese in weight percent,
and an inhomogeneous repartition of manganese characterized by a manganese distribution with a slope above or equal to −30.

The microstructure of the steel sheet according to the invention contains from 30% to 55% of retained austenite and preferably from 30 to 50% of austenite. Below 30% or above 55% of austenite, the uniform and total elongation can not reach the targeted values.

Such austenite is formed during the intercritical annealing of the hot-rolled steel sheet but also during the intercritical annealing of the cold rolled steel sheet. During the intercritical annealing of the hot rolled steel sheet, areas containing a manganese content higher than nominal value and areas containing manganese content lower than nominal value are formed, creating a heterogeneous distribution of manganese. Carbon co-segregates with manganese accordingly. This manganese heterogeneity is measured thanks to the slope of manganese distribution for the hot rolled steel sheet, which must be above or equal to −30, as shown in FIG. 2 and explained later.

The microstructure of the steel sheet according to the invention contains from 45% to 70% of ferrite, preferably from 50 to 70% of ferrite. Such ferrite is formed during the intercritical annealing of the hot-rolled steel sheet but also during the intercritical annealing of the cold rolled steel sheet.

Fresh martensite can be present up to 5% in surface fraction but is not a phase that is desired in the microstructure of the steel sheet according to the invention. It can be formed during the final cooling step to room temperature by transformation of unstable austenite. Indeed, this unstable austenite with low carbon and manganese contents leads to a martensite start temperature Ms above 20° C. To obtain the final mechanical properties, the fresh martensite is limited to a maximum of 5%, preferably to a maximum of 3%, or better reduced to 0.

The carbon [C]_{A} and manganese [Mn]_{A} contents in austenite, expressed in weight percent, are such that [C]_{A}*[Mn]_{A}/((0.1+C %²)*(Mn %+2))≥1.10

C % and Mn % being the nominal values in carbon and manganese in weight percent. When the equation value is below 1.10, it is not possible to ensure a satisfactory elongation to the steel sheet

Preferably, the density of carbides of the cold rolled and annealed steel sheet is below or equal to 1×10⁶/mm².

The cold rolled and annealed steel sheet according to the invention has a tensile strength above or equal to 1050 MPa, a uniform elongation UE above or equal to 13% and a total elongation TE above or equal to 15%.

Preferably, the cold rolled and annealed steel sheet has a yield strength above or equal to 780 MPa.

Preferably, the cold rolled and annealed steel sheet has a LME index below 0.36.

Preferably, the cold rolled and annealed steel sheet has hole expansion ratio HE above or equal to 15%.

According to the invention, the cold rolled and annealed steels sheet has preferably a carbon equivalent Ceq lower than 0.4% to improve weldability. The carbon equivalent is defined as Ceq=C %+Si %/55+Cr %/20+Mn %/19−Al %/18+2.2P %−3.24B %−0.133*Mn %*Mo % with elements being expressed by weight percent.

In a preferred embodiment, the tensile strength TS expressed in MPa, yield strength YS expressed in MPa, uniform elongation UE expressed in % and total elongation TE expressed in %, of the cold rolled and annealed steel sheet are such that they satisfy the following equation:

[(TS−800)×(YS−300)×UE×TE]/[(0.1+C %)×Mn %]>3.3×10⁷

where C % and Mn % correspond to the nominal carbon and manganese contents in weight percent.

A welded assembly can be manufactured by producing two sheets of cold rolled and annealed steel, and resistance spot welding the two steel parts.

The resistance spot welds joining the first sheet to the second sheet are characterized by a high resistance in cross-tensile test defined by an a value of at least 30 daN/mm2.

The steel sheet according to the invention can be produced by any appropriate manufacturing method and the person skilled in the art can define one. It is however preferred to use the method according to the invention comprising the following steps:

A semi-product able to be further hot-rolled, is provided with the steel composition described above. The semi product is heated to a temperature from 1150° C. to 1300° C., so to make it possible to ease hot rolling, with a final hot rolling temperature FRT comprises from 800° C. to 1000° C. Preferably, the FRT is from 850° C. to 950° C.

The hot-rolled steel is then cooled and coiled at a temperature Tam from 20° C. to 600° C. The hot rolled steel sheet is then cooled to room temperature and can be pickled.

The hot rolled steel sheet is then heated up to an annealing temperature T_{HBA} between Ac1 and Ac3. Preferably the temperature T_{HBA} is comprised from Ac1+5° C. to Ac3. Preferably the temperature T_{HBA} is from 580° C. to 680° C. The steel sheet is maintained at said temperature T_{HBA} for a holding time t_{HBA} from 0.1 to 120 h to promote manganese diffusion and formation of inhomogeneous manganese distribution.

T_{HBA} is chosen to obtain after cooling, 10 to 60% of austenite and 40 to 90% of ferrite, the fraction of precipitated carbides being maintained below 0.8%. In particular, the selection of the appropriate time and temperature of such intercritical annealing must consider the maximum carbide fractions that can be tolerated according to the invention. In particular, T_{HBA} is chosen by the skilled man to limit carbide precipitation, keeping in mind that increasing T_{HBA} limits carbide precipitation.

Regarding chemical composition, the higher the amount of carbon and aluminium in the steel, the greater the concentration of carbides for a given temperature. This means that for carbon and aluminium contents in the upper part of the claimed ranges, T_{HBA} must be increased to limit carbides precipitation accordingly.

Moreover, the lower the amount of manganese in the steel, the higher the carbide concentration for a given temperature. This means that for manganese content in the lower part of the claimed range, T_{HBA} must be increased to limit carbides precipitation accordingly.

The hot rolled and heat-treated steel sheet is then cooled to room temperature and can be pickled to remove oxidation.

The hot rolled and heat-treated steel sheet is then cold rolled at a reduction rate from 20% to 80%.

The cold rolled steel sheet is then annealed at an intercritical temperature Tₛₒₐₖ comprised between Ac1 and Ac3 of the cold rolled steel sheet. Ac1 and Ac3 are determined through dilatometry tests. The skilled man has to select an optimal temperature Tₛₒₐₖ low enough in order to limit formation of unstable austenite and of fresh martensite during the last cooling step. This optimal temperature depends in particular on carbon, manganese and aluminium content. The higher the aluminium content, the higher the soaking temperature to stabilize austenite. The higher the carbon or manganese content, the lower the soaking temperature to stabilize austenite.

Preferably the intercritical temperature Tₛₒₐₖ is from 600° C. to 760° C. The steel sheet is maintained at said temperature Tₛₒₐₖ for a holding time tₛₒₐₖ from 10 to 180000 s to obtain a sufficiently recrystallized microstructure.

The cold rolled and annealed steel sheet is then cooled to room temperature.

The sheet can then be coated by any suitable process including hot-dip coating, electrodeposition or vacuum coating of zinc or zinc-based alloys or of aluminium or aluminium-based alloys.

The invention will be now illustrated by the following examples, which are by no way limitative.

### Examples

Seven grades, whose compositions are gathered in table 1, were cast in semi-products and processed into steel sheets

TABLE 1
Compositions
The tested compositions are gathered in the following table wherein the
element contents are expressed in weight percent.

| | | | | | | | | | | | | | Ac1 | Ac3 |
|---|---|---|---|---|---|---|---|---|---|---|---|---|---|---|
| Steel | C | Mn | Al | Mo | B | S | P | N | Si | Nb | Ti | Ceq | (° C.) | (° C.) |
| A | 0.07 | 7.9 | 0.90 | 0.32 | 0.002 | 0.0015 | 0.011 | 0.003 | — | 0.032 | 0.015 | 0.15 | 560 | 830 |
| B | 0.10 | 7.6 | 0.92 | 0.22 | 0.0018 | 0.0022 | 0.013 | 0.004 | 0.31 | — | 0.025 | 0.29 | 560 | 810 |
| C | 0.07 | 10.0 | 2.14 | 0.31 | 0.0025 | 0.0016 | 0.006 | 0.003 | 0.05 | 0.033 | 0.015 | 0.15 | 560 | 865 |
| D | 0.05 | 8.0 | 1.03 | 0.31 | 0.003 | 0.001 | 0.004 | 0.002 | 0.04 | 0.035 | 0.015 | 0.12 | 560 | 835 |
| E | 0.15 | 7.7 | 0.96 | 0.22 | 0.0028 | 0.0022 | 0.012 | 0.003 | 0.02 | — | 0.018 | 0.33 | 560 | 820 |
| F | 0.15 | 7.7 | 0.94 | 0.22 | 0.0027 | 0.0022 | 0.012 | 0.003 | 0.02 | — | 0.018 | 0.33 | 560 | 820 |
| G | 0.20 | 4.8 | 0.02 | — | — | 0.001 | 0.02 | 0.004 | 1.51 | — | — | 0.52 | 610 | 765 |

Ac1 and Ac3 temperatures have been determined through dilatometry tests on the cold-rolled steel sheet and metallography analysis.

TABLE 2
Process parameters of the hot rolled and heat-treated steel sheets
Steel semi-products, as cast, were reheated at 1200° C., hot rolled
and then coiled at 450° C. The hot rolled and coiled steel sheets
are then heat treated at a temperature T_{HBA} and maintained
at said temperature for a holding time t_{HBA}. The following
specific conditions to obtain the hot rolled and heat-treated
steel sheets were applied:

| | | Hot rolling | Hot band annealing (HBA) | |
|---|---|---|---|---|
| Trials | Steel | FRT (° C.) | T_{HBA}(° C.) | t_{HBA}(h) |
| 1 | A | 800 | 640 | 10 |
| 2 | A | 800 | 630 | 40 |
| 3 | A | 800 | 640 | 10 |
| 4 | A | 800 | 640 | 10 |
| 5 | A | 800 | 640 | 10 |
| 6 | B | 820 | 640 | 40 |
| 7 | B | 820 | 640 | 40 |
| 8 | B | 820 | 640 | 40 |
| 9 | C | 900 | 620 | 10 |
| 10 | D | 900 | — | — |
| 11 | D | 900 | — | — |
| 12 | E | 850 | 630 | 40 |
| 13 | F | 850 | 640 | 10 |
| 14 | F | 850 | 640 | 10 |
| 15 | F | 850 | 640 | 10 |
| 16 | G | 930 | 600 | 5 |

Underlined values: parameters which do not allow to obtain the targeted properties

The hot rolled and heat-treated steel sheets were analyzed and the corresponding properties are gathered in table 3.

TABLE 3
Microstructure and properties of the hot
rolled and heat-treated steel sheet
On the contrary, for trial 10, the absence of heat
treatment after hot rolling implies that the repartition of
manganese is not heterogeneous, which can be seen by the
value of the slope of the manganese distribution lower
than −30. This distribution in manganese will not allow
mechanical properties to be achieved. This is also the
case for trial 11.

| | Slope of the Mn | |
|---|---|---|
| Trials | distribution | Charpy energy (J/mm²) |
| 1 | −13 | 1.22 |
| 2 | −25 | 1.26 |
| 3 | −13 | 1.22 |
| 4 | −13 | 1.22 |
| 5 | −13 | 1.22 |
| 6 | −20 | 1.00 |
| 7 | −20 | 1.00 |
| 8 | −20 | 1.00 |
| 9 | −12 | 1.25 |
| 10 | −69 | 0.94 |
| 11 | −69 | 0.94 |
| 12 | −27 | 0.68 |
| 13 | −25 | 0.60 |
| 14 | −25 | 0.60 |
| 15 | −25 | 0.60 |
| 16 | n.d | 0.05 |

Underlined values: do not match the targeted values.
n.d.: not determined

The slope of the manganese distribution and the Charpy impact energy at 20° C. were determined.

The Charpy impact energy is measured according to Standard ISO 148-1:2006 (F) and ISO 148-1:2017(F).

The heat treatment of the hot rolled steel sheet allows manganese to diffuse in austenite: the repartition of manganese is heterogeneous with areas with low manganese content and areas with high manganese content. This manganese heterogeneity helps to achieve mechanical properties and can be measured thanks to manganese distribution.

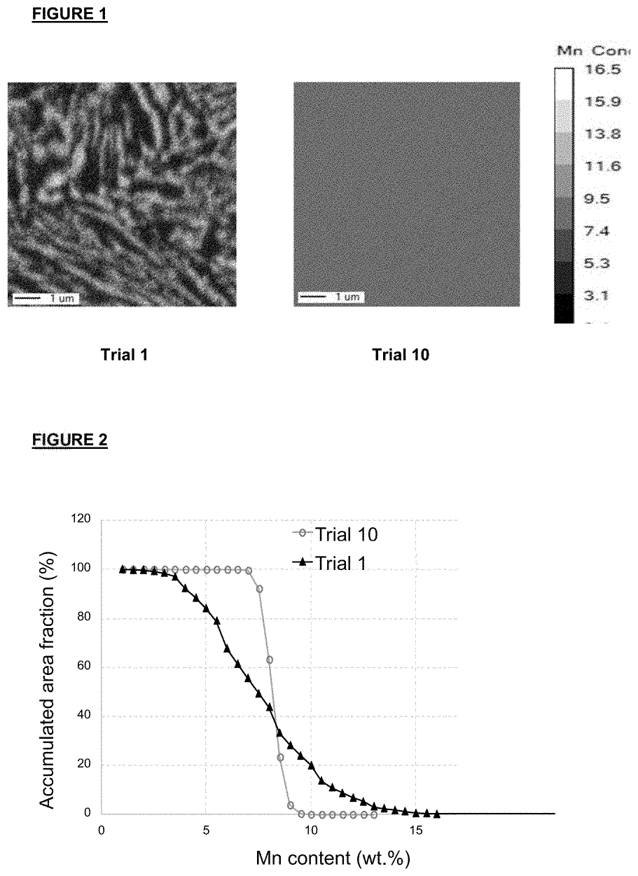

FIG. 1 represents a section of the hot rolled and heat-treated steel sheet of trial 1 and trial 10. The black area corresponds to area with lower amount of manganese, the grey area corresponds to a higher amount of manganese.

This figure is obtained through the following method: a specimen is cut at ¼ thickness from the hot rolled and heat-treated steel sheet and polished.

The section is afterwards characterized through electron probe micro-analyzer, with a Field Emission Gun (“FEG”) at a magnification greater than 10000× to determine the manganese amounts. Three maps of 10 μm*10 μm of different parts of the section were acquired. These maps are composed of pixels of 0.01 μm². Manganese amount in weight percent is calculated in each pixel and is then plotted on a curve representing the accumulated area fraction of the three maps as a function of the manganese amount.

This curve is plotted in FIG. 2 for trial 1 and trial 10: 100% of the sheet section contains more than 1% of manganese. For trial 1, 20% of the sheet section contains more than 10% of manganese.

The slope of the curve obtained is then calculated between the point representing 80% of accumulated area fraction and the point representing 20% of accumulated area fraction. For trial 1, this slope is higher than −30, showing that the repartition of manganese is heterogeneous, with areas with low manganese content and areas with high manganese content.

TABLE 4
Process parameters of the cold rolled and annealed steel sheets
The hot rolled and heat-treated steel sheet obtained are then cold
rolled at a reduction rate of 50%. The cold rolled steel sheet are
then annealed at a temperature Tₛₒₐₖ between Ac1 and Ac3 of
the cold rolled steel sheet and maintained at said temperature for
a holding time tₛₒₐₖ, before being cooled to room temperature.
The following specific conditions to obtain the cold rolled and
annealed steel sheets were applied:

Annealing

| Trials | Tₛₒₐₖ(° C.) | tₛₒₐₖ(S) |
|---|---|---|
| 1 | 670 | 250 |
| 2 | 680 | 250 |
| 3 | 690 | 250 |
| 4 | 700 | 120 |
| 5 | 720 | 100 |
| 6 | 670 | 120 |
| 7 | 690 | 120 |
| 8 | 710 | 120 |
| 9 | 670 | 1800 |
| 10 | 670 | 3600 |
| 11 | 675 | 300 |
| 12 | 690 | 120 |
| 13 | 690 | 120 |
| 14 | 700 | 120 |
| 15 | 710 | 120 |

Underlined values: parameters which do not allow to obtain the targeted properties

The cold rolled and annealed sheets were then analyzed, and the corresponding microstructure elements, mechanical properties and weldability properties were respectively gathered in table 5, 6 and 7.

TABLE 5
Microstructure of the cold rolled and annealed steel sheet
The phase percentages of the microstructures of the obtained cold rolled and
annealed steel sheet and the slope of the manganese distribution were determined.

| | Retained | | | | | | Carbides | |
|---|---|---|---|---|---|---|---|---|
| | austenite | Ferrite | Martensite | [C]_{A}* [Mn]_{A}/ | [C]_{A} | [Mn]_{A} | density | Slope of the |
| Trials | (%) | (%) | (%) | ((0.1 + C %²)*(Mn % + 2)) | (% wt) | (% wt) | (×10⁶/mm²) | Mn distribution |
| 1 | 36 | 64 | — | 1.48 | 0.15 | 10.3 | 0 | −13 |
| 2 | 40 | 60 | — | 1.20 | 0.14 | 9.0 | 0 | −25 |
| 3 | 43 | 57 | — | 1.25 | 0.13 | 10.1 | 0 | −13 |
| 4 | 45 | 55 | — | 1.25 | 0.13 | 10.1 | 0 | −14 |
| 5 | 50 | 50 | — | 1.02 | 0.11 | 9.7 | 0 | −14 |
| 6 | 38 | 62 | — | 1.79 | 0.22 | 8.6 | 0.2 | −20 |
| 7 | 45 | 55 | — | 1.51 | 0.19 | 8.4 | 0.1 | −20 |
| 8 | 35 | 35 | 30 | 1.09 | 0.14 | 8.2 | 0.1 | −21 |
| 9 | 48 | 50 | — | 1.10 | 0.12 | 11.5 | 0 | −12 |
| 10 | 15 | 40 | 45 | 0.57 | 0.07 | 8.3 | 0 | <−30 |
| 11 | 44 | 56 | — | 0.75 | 0.09 | 8.5 | 0 | <−30 |
| 12 | 35 | 40 | 25 | 1.68 | 0.22 | 9.1 | 2 | −27 |
| 13 | 50 | 50 | — | 2.02 | 0.26 | 9.3 | 0.3 | −26 |
| 14 | 53 | 47 | — | 1.85 | 0.24 | 9.2 | 0.2 | −26 |
| 15 | 55 | 40 | 5 | 1.69 | 0.22 | 9.2 | 0.2 | −26 |

Underlined values: not corresponding to the invention

[C]_{A} and [Mn]_{A} corresponds to the amount of carbon and manganese in austenite, in weight percent. They are measured with both X-rays diffraction (C %) and electron probe micro-analyzer, with a Field Emission Gun (Mn %).

The surface fractions of phases in the microstructure are determined through the following method: a specimen is cut from the cold rolled and annealed steel sheet, polished and etched with a reagent known per se, to reveal the microstructure. The section is afterwards examined through scanning electron microscope, for example with a Scanning Electron Microscope with a Field Emission Gun (“FEG-SEM”) at a magnification greater than 5000×, in secondary electron mode.

The determination of the surface fraction of ferrite is performed thanks to SEM observations after Nital or Picral/Nital reagent etching.

The determination of the volume fraction of retained austenite is performed thanks to X-ray diffraction.

The density of precipitated carbides is determined thanks to a section of sheet examined through Scanning Electron Microscope with a Field Emission Gun (“FEG-SEM”) and image analysis at a magnification greater than 15000×.

The heterogeneity of the manganese distribution obtained after the annealing of the hot rolled steel sheet is conserved after the cold rolling and annealing of the steel sheet. It can be seen by comparing slope of the manganese distribution obtained after annealing of the hot rolled steel sheet (in Table 3) and the slope of the manganese distribution obtained after the annealing of the cold rolled steel sheet (Table 5). These values are significantly the same.

TABLE 6
Mechanical properties of the cold rolled and annealed steel sheet
Mechanical properties of the obtained cold rolled and annealed were
determined and gathered in the following table.
The yield strength YS, the tensile strength TS and the uniform elongation TE
are measured according to ISO standard ISO 6892-1, published in October 2009.
The hole expansion ratio HE is measured according to ISO standard 16630: 2009.

| | | | | | | [(TS − 800) × (YS − 300) × UE × TE] / |
|---|---|---|---|---|---|---|
| Trials | TS (MPa) | UE (%) | TE(%) | YS (MPa) | HE (%) | [(0.1 + C %) × Mn %] |
| 1 | 1114 | 15 | 18 | 1038 | 37 | 46001561 |
| 2 | 1133 | 14 | 16 | 939 | Nd | 34270740 |
| 3 | 1149 | 14 | 18 | 991 | 29 | 47284390 |
| 4 | 1154 | 15 | 18 | 950 | 28 | 46172373 |
| 5 | 1245 | 9 | 10 | 762 | Nd | 14042531 |
| 6 | 1079 | 17 | 22 | 967 | Nd | 45183477 |
| 7 | 1160 | 17 | 18 | 823 | Nd | 38179893 |
| 8 | 1247 | 10 | 13 | 634 | Nd | 12414258 |
| 9 | 1062 | 18 | 21 | 961 | Nd | 38486288 |
| 10 | 1264 | 7 | 10 | 770 | Nd | 12868537 |
| 11 | 1216 | 11 | 13 | 805 | Nd | 23345140 |
| 12 | 1214 | 11 | 13 | 737 | Nd | 23401118 |
| 13 | 1231 | 23 | 24 | 949 | 22 | 80724893 |
| 14 | 1278 | 15 | 21 | 863 | 15 | 44097048 |
| 15 | 1337 | 16 | 17 | 713 | 12 | 31409399 |

Underlined values: do not match the targeted values
nd: non determined value

The examples show that the steel sheets according to the invention, namely examples 1-4, 6-7, 9 and 13-14 are the only one to show all the targeted properties thanks to their specific compositions and microstructures.

Trials 1 to 5 have been performed with steel composition A. Different trials have been performed by modifying Tₛₒₐₖ to find the optimal temperature to limit formation of fresh martensite during the last cooling step and formation of unstable austenite. For trials 1 to 4, the chosen annealing temperature Tₛₒₐₖ allows to obtain those characteristics. The stability of austenite is obtained thanks to the amount of carbon and manganese in austenite, which can be seen from the expression [C]_{A}*[Mn]_{A}/((0.1+C %²)*(Mn %+2)) greater than 1.10. In trial 5, the cold rolled steel sheet is annealed at a higher Tₛₒₐₖ temperature of 720° C., leading to a high amount of austenite with less carbon, which can be seen by the expression [C]_{A}*[Mn]_{A}/((0.1+C %²)*(Mn %+2)) lower than 1.10. This unstable austenite leads to a decrease of UE and TE compared to trials 1 to 4.

Trials 6 to 8 are performed with steel composition B. For trials 6 and 7, Tₛₒₐₖ is chosen in order to limit formation of fresh martensite during the last cooling step. In trial 8, the cold rolled steel sheet is annealed at a higher Tₛₒₐₖ temperature than trials 6 and 7, thus forming more austenite. During the last cooling step, 30% of fresh martensite are then formed due to this high amount of austenite formed during the annealing. This high amount of fresh martensite does not allow to obtain targeted mechanical properties.

In trials 10 and 11, the absence of heat treatment after hot rolling implies that the repartition of manganese is not heterogeneous, which can be seen by the value of the slope of the manganese distribution lower than −30, even after the annealing of the cold rolled steel sheet. This distribution in manganese does not allow mechanical properties to be achieved.

In trial 12, the hot rolled steel sheet is heat treated with a too low T_{HBA} temperature leading to formation of more than 0.5% of precipitated carbides, as seen in Table 3. These precipitated carbides are not dissolved after annealing of the cold rolled steel sheet, where a density of carbides of 2·10⁶/mm² is observed. The presence of carbides of the cold rolled steel sheet, leads to the formation of 25% of fresh martensite during last cooling step. This high amount of fresh martensite does not allow to obtain targeted mechanical properties.

Trials 13 to 15 are performed with steel composition F. For trials 13 and 14, Tₛₒₐₖ is chosen in order to limit formation of fresh martensite during the last cooling step. In trial 15, the cold rolled steel sheet is annealed at a higher Tₛₒₐₖ temperature than trials 13 and 14, thus forming more austenite. During the last cooling step, 5% of fresh martensite are then formed due to this high amount of austenite formed during the annealing. This amount of fresh martensite does not allow to obtain targeted mechanical properties.

TABLE 7
Weldability properties of the cold rolled and annealed steel sheet
Weldability properties of the obtained cold rolled and annealed were
determined and gathered in the following table:

| Trials | α (daN/mm²) | LME index |
|---|---|---|
| 1 | 60 | 0.07 |
| 2 | 60 | 0.07 |
| 3 | 60 | 0.07 |
| 4 | 60 | 0.07 |
| 5 | 60 | 0.07 |
| 6 | 55 | 0.18 |
| 7 | 55 | 0.18 |
| 8 | 55 | 0.18 |
| 9 | 68 | 0.08 |
| 10 | 60 | 0.06 |
| 11 | 60 | 0.06 |
| 12 | 40 | 0.16 |
| 13 | 40 | 0.16 |
| 14 | 40 | 0.16 |
| 15 | 40 | 0.16 |
| 16 | 24 | 0.58 |

LME index = C % + Si %/4, in wt %.

Spot welding in standard ISO 18278-2 condition have been done on the cold rolled and annealed steel sheets.

In the test used, the samples are composed of two sheets of steel in the form of cross welded equivalent. A force is applied so as to break the weld point. This force, known as cross tensile Strength (CTS), is expressed in daN. It depends on the diameter of the weld point and the thickness of the metal, that is to say the thickness of the steel and the metallic coating. It makes it possible to calculate the coefficient α which is the ratio of the value of CTS on the product of the diameter of the welded point multiplied by the thickness of the substrate. This coefficient is expressed in daN/mm2.

In trial 16, the chemical composition with a high amount of carbon or silicon in the steel sheet does not allow to obtain weldability properties of the invention.

What is claimed is:

1-11. (canceled)

12. A cold rolled and annealed steel sheet, made of a steel having a composition comprising, by weight percent:
C: 0.03-0.18%
Mn: 6.0-11.0%
Al: 0.2-3%
Mo: 0.05-0.5%
B: 0.0005-0.005%
S≤0.010%
P≤0.020%
N≤0.008%
and optionally one or more of the following elements, in weight percentage:
Si≤1.20%
Ti≤0.050%
Nb≤0.050%
Cr≤0.5%
V≤0.2%
a remainder of the composition being iron and unavoidable impurities resulting from processing,
the steel sheet having a microstructure comprising, in surface fraction, from 30% to 55% of retained austenite, from 45% to 70% of ferrite, and less than 5% of fresh martensite;
a carbon [C]_{A} and manganese [Mn]_{A} content in austenite, expressed in weight percent, satisfying
[C]_{A}*[Mn]_{A}/((0.1+C %²)*(Mn %+2))≥1.10
C % and Mn % being the nominal values in carbon and manganese in weight percent, and
an inhomogeneous repartition of manganese defined by a manganese distribution with a slope above or equal to −30.

13. The cold rolled and annealed steel sheet as recited in claim 12 wherein the carbon content is from 0.05% to 0.15%.

14. The cold rolled and annealed steel sheet as recited in claim 12 wherein the manganese content is from 6.5% to 9.0%.

15. The cold rolled and annealed steel sheet as recited in claim 12 wherein the aluminium content is from 0.5% to 1.5%.

16. The cold rolled and annealed steel sheet as recited in claim 12 wherein the microstructure comprises a density of carbides below or equal to 1·10⁶/mm².

17. The cold rolled and annealed steel sheet as recited in claim 12 wherein the tensile strength is above or equal to 1050 MPa, the yield strength is above or equal to 780 MPa, the uniform elongation UE is above or equal to 13% and the total elongation TE is above or equal to 15%.

18. The cold rolled and annealed steel sheet as recited in claim 12 wherein the LME index is below 0.36.

19. The cold rolled and annealed steel sheet as recited in claim 12 wherein the hole expansion ratio HE is above or equal to 15%.

20. The cold rolled and annealed steel sheet as recited in claim 12 wherein the steel has a carbon equivalent Ceq lower than 0.4%, the carbon equivalent being defined as
Ceq=C %+Si %/55+Cr %/20+Mn %/19−Al %/18+2.2P %−3.24B %−0.133*Mn %*Mo %
with elements being expressed by weight percent.

21. The cold rolled and annealed steel sheet as recited in claim 12 wherein tensile strength TS expressed in MPa, yield strength YS expressed in MPa, uniform elongation UE expressed in % and total elongation TE expressed in %, satisfy following equation:
[(TS−800)×(YS−300)×UE×TE]/[(0.1+C%)×Mn %]>3 0.3×10⁷
where C % and Mn % correspond to the carbon and manganese content in the bulk, in weight percent.

22. A resistance spot weld of two steel parts of the cold rolled and annealed steel sheet as recited in claim 12, the resistance spot weld having an α value of at least 30 daN/mm².
